(19) United States
(12) Patent Application Publication
(10) Pub. No.: US 2013/0174378 A1
(43) Pub. Date: Jul. 11, 2013

(54) Retractable Casket Handle

(71) Applicants: Gerald H. Davis, Fountain City, IN (US); Chad L. Eversole, Richmond, IN (US); Gary L. Cox, Richmond, IN (US); Richard D. Brown, Lynn, IN (US)

(72) Inventors: Gerald H. Davis, Fountain City, IN (US); Chad L. Eversole, Richmond, IN (US); Gary L. Cox, Richmond, IN (US); Richard D. Brown, Lynn, IN (US)

(73) Assignee: VANDOR CORPORATION, Richmond, IN (US)

(21) Appl. No.: 13/544,944

(22) Filed: Jul. 9, 2012

Related U.S. Application Data
(60) Provisional application No. 61/505,905, filed on Jul. 8, 2011.

(51) Int. Cl. A61G 19/00

(52) U.S. Cl. CPC A61G 19/00
USPC 16/429

(57) ABSTRACT

A retractable handle arrangement for a casket includes an elongate handle member, a rigid rod, and a stopper member. The elongate handle member has a length extending parallel to a side panel of the casket, and has a through-hole extending transverse to the length. The rigid rod extends through the through-hole of the handle member. The rigid rod has a first end and a second end, the first end having a head. The head has a diameter exceeding a diameter of at least a part of the through-hole. The rigid rod extends through a side panel opening such that the second end is disposed within an interior of the casket. The stopper member is fixedly supported on the rigid rod within the interior of the casket. The stopper member has a diameter that exceeds a diameter of at least a portion of the side panel opening.

This application claims the benefit of U.S. Provisional Patent application Ser. No. 61/505,905, filed Jul. 8, 2011, which is incorporated herein by reference.

### FIELD OF THE INVENTION

The present invention relates generally to handles, and more particularly, to handles for caskets.

### BACKGROUND

Burial containers and cremation containers, collectively caskets, often include handles to aid in transport of the deceased, by way of example, from the location of the memorial ceremony to the place of interment or crematory. For typical caskets formed of metal or wood products, the handles are fixedly attached to the outside of a casket. Handles, and their connection to the caskets themselves, require significant structural strength in order to support the weight of the casket and the deceased. To satisfy this requirement, handles of current design invariably increase the overall width dimension of the casket, which adds to shipping costs and can increase the space required at the interment site, and/or of the burial vault.

To this end, it will be appreciated that a typical casket handle adds at least six inches beyond the width of the casket that can be used to contain the deceased. Each handle must be placed at least two inches away from the outer surface of the casket to allow for the hand of the carrier to grasp the handle. Moreover, each handle must be at least on the order of an inch thick to provide an ergonomic grasping surface. Thus, the handle must extend at least three inches on each side, totaling at least an additional six inches in width, and typically more.

One method of implementing a handle with limited increase in dimension is to employ a movable handle that rests against the side of the casket when not in use. Such handles may be rotated up and sufficiently away from the casket side to allow the handles to be gripped when the casket is to be moved. One such system employs pivotally connected handles that pivot outward to allow the carrier to grip the handle. A disadvantage of such systems arises from the significant forces on the pivot joint when the casket is being lifted. The parts and structures of sufficient strength to handle such forces can require relatively costly materials. Other moveable handle mechanisms also contain many parts and are relatively expensive to manufacture.

There is therefore a need for a movable handle mechanism for a casket that is of reduced expense, and yet strong enough to support the casket with the deceased inside.

### SUMMARY

The present invention addresses the above-stated need, as well as others, by providing a sliding handle mechanism formed of a rigid rod and a stopping member, connected to an elongate handle member, that allows sliding movement of the handle member from a retracted position to an extended position used for carrying. The use of a rigid rod and a stopping member to facilitate the movement allows for a simpler design of a moveable handle.

Accordingly, a first embodiment is a retractable handle arrangement for a casket that includes an elongate handle member, a rigid rod, and a stopper member. The elongate handle member has a length extending parallel to a side panel of the casket, and has a through-hole extending transverse to the length. The rigid rod extends through the through-hole of the handle member. The rigid rod has a first end and a second end, the first end having a head. The head has a diameter exceeding a diameter of at least a part of the through-hole. The rigid rod extends through a side panel opening such that the second end is disposed within an interior of the casket. The stopper member is fixedly supported on the rigid rod within the interior of the casket. The stopper member has a diameter that exceeds a diameter of at least a portion of the side panel opening.

The above described features and advantages, as well as others, will become readily apparent to those of ordinary skill in the art by reference to the following detailed description and accompanying drawings.

### BRIEF DESCRIPTION OF THE DRAWINGS

FIG. 1 shows a perspective view of a casket base that incorporates a handle mechanism according to first embodiment;

FIG. 2 shows a fragmentary cutaway of the casket base and handle mechanism of FIG. 1 in a first position;

FIG. 3 shows a fragmentary cutaway of the casket base and handle mechanism of FIG. 1 in a second position;

FIG. 4 shows a fragmentary cutaway of the casket base and handle mechanism of FIG. 1 with an alternative slider arrangement in a first position;

FIG. 5 shows a fragmentary cutaway of the casket base and handle mechanism of FIG. 1 with the alternative slider arrangement of FIG. 4 in a second position;

FIG. 6 shows a fragmentary cutaway of the casket base and handle mechanism of FIG. 1 with another alternative slider arrangement in a first position;

FIG. 7 shows a fragmentary cutaway of the casket base and handle mechanism of FIG. 1 with the alternative slider arrangement of FIG. 6 in a second position; and

FIG. 8 shows a perspective view of a casket base and an alternative handle mechanism.

### DESCRIPTION

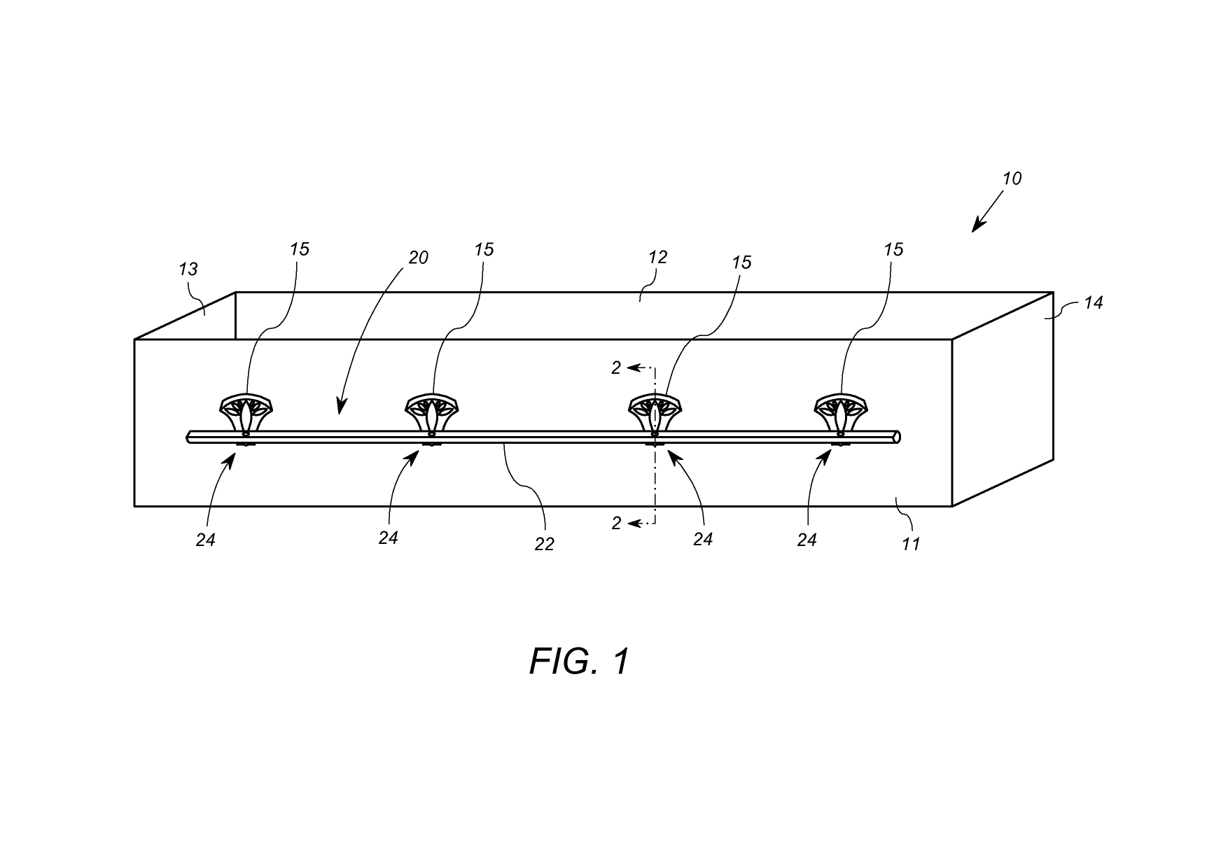

FIG. 1 is a perspective view of a casket base 10 that incorporates a handle mechanism according to at least one embodiment of the invention. The casket base 10 includes a first side panel 11, a second side panel 12, a head panel 13, a foot panel 14, and a base panel (not shown in FIG. 1). The first side panel 11, second side panel 12, head panel 13, and foot panel 14 are arranged with the base panel in any suitable manner known in the art to create an open box slightly larger than and/or otherwise configured to retain a human body. The first side panel 11, second side panel 12, head panel 13, and foot panel 14 are preferably constructed of wood, such as MDF or plywood, but may be of any material normally used for caskets. The casket base 10 is intended to be used in conjunction with a suitable casket lid, not shown in FIG. 1, but which would be known to those of ordinary skill in the art.

The casket base 10 includes at least one retractable handle arrangement 20 according to at least one exemplary embodiment of the invention. While FIG. 1 shows a first retractable handle arrangement 20 supported on the first side panel 11, it will be appreciated that the casket base 10 in this embodiment includes a second retractable handle arrangement, substantially identical to the first retractable handle arrangement. The retractable handled arrangement 20 includes an elongate handle member 22 and a plurality of slide mechanisms 24. In the embodiment of FIG. 1, the retractable handle arrangement 20 further includes a plurality of molded plaques 15 spaced along the length of the first side panel 11 on the outside of the casket base 10. The molded plaques 15 may suitably include a decorative design.

The elongate handle member 22 may suitably be a bar or similar rigid elongate structure having a length extending parallel to, but not the entire extent of, the first side panel 11 of the casket base 10. The elongate handle member 22 preferably has a diameter that is configured for gripping by a human hand in a comfortable manner. It will be appreciated, that the term “diameter” herein shall be used to describe not only the width of an element having a circular shape or cross-section, but also the widest width of a cross-section of any elongate member. Thus, if the elongate handle member 22 had a roughly square cross-section, the “diameter” would be the distance between opposing corners thereof.

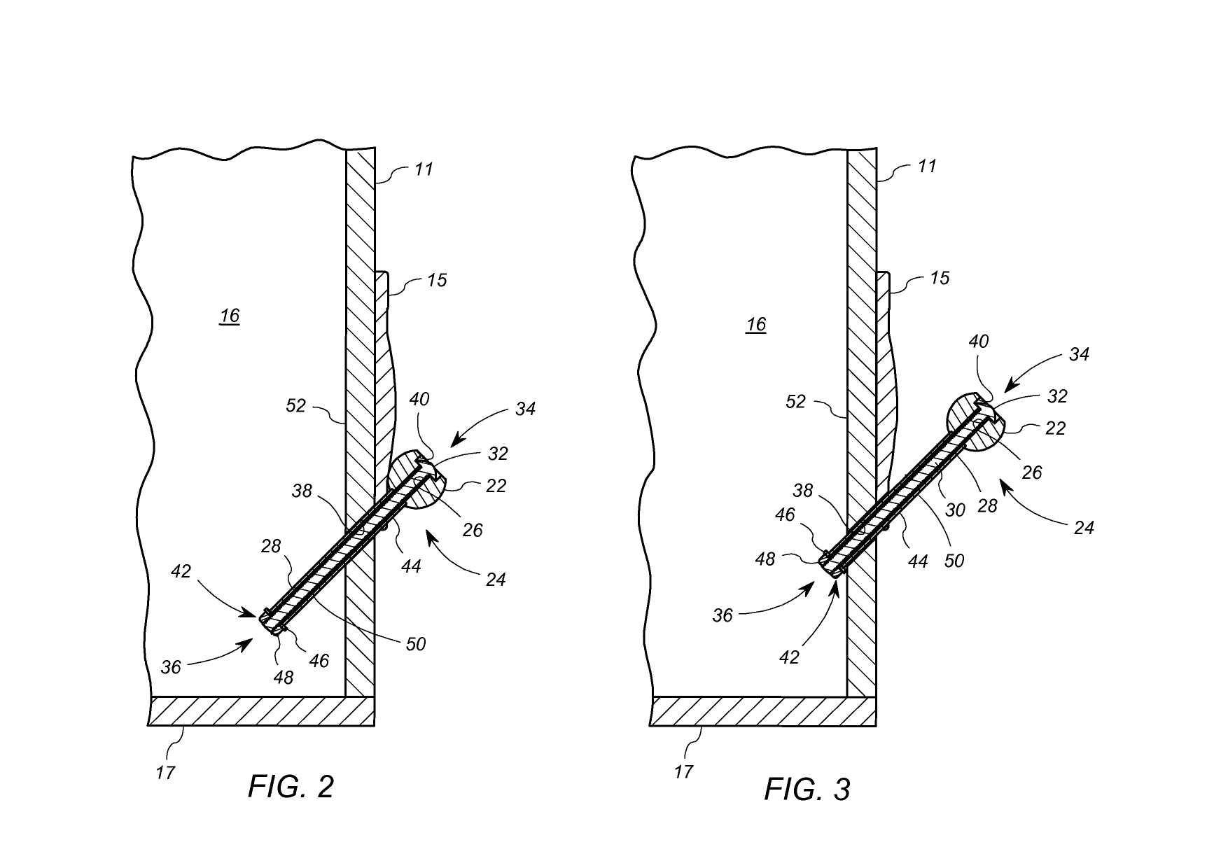

As shown in FIGS. 2 and 3 and discussed further below, the elongate handle member 22 has a plurality of through holes that extend transverse to the length of the elongate handle member 22. FIG. 2, for example, shows a cross-section of FIG. 1 in which a first through hole 26 of the elongate handle member 22 is illustrated. FIG. 3 shows a similar view.

Referring again to FIG. 1, the plurality slide mechanisms 24 include four slide mechanisms 24 disposed at spaced apart locations along the length of the elongate handle member 22. As will become apparent below, the slide mechanisms 24 correspond in location to the locations of the molded plaques 15 on the first side panel 11. In general, the slide mechanisms 24 are configured to allow the elongate handle member 22 to be movable from a first position to a second position. In the first position, which is illustrated in FIG. 2, the elongate handle member 22 is adjacent to the first side panel 11. In the second position, which is illustrated in FIG. 3, the elongate handle member 22 is further spaced from the first side panel 11 by an amount sufficient to comfortably allow the gripping fingers and palms of pallbearers or other persons to pass comfortably between the side panel 11 and the elongate handle member 22. In general, by allowing movement of the elongate handle member 22 to move between the first position and the second position, the retractable handle arrangement 20 creates a casket handle that is convenient for lifting in the second position (FIG. 3), while requiring less space for transit in the first position (FIG. 2).

Referring now to FIGS. 2 and 3, a first slide mechanism 24 is shown in context with the side panel 11 and base panel 17 of the casket base 10. The base panel 17 forms the bottom of the box of the casket base 10, and is secured between the panels 11, 12, 13 and 14 of FIG. 1. As shown in FIGS. 2 and 3, the slide mechanism 24 includes a rigid rod 28, a stopper member 42 and a sleeve 44. The rigid rod 28 is an elongate rod member that includes a first end 34 disposed at or near a portion of the elongate handle member 22, and a second end 36 disposed within the interior 16 of the casket base 10. Accordingly, the rigid rod 28 passes through an opening 38 in the side panel 11. The opening 38 is arranged at an inclined angle with respect to the side panel 11, such that the opening 38 extends upward and outward from the interior 16 of the casket base 10 toward the exterior casket base 10. The rigid rod 28 includes a head 32 disposed at the first end 34. The head 32 is a structure that has a diameter exceeding a diameter of at least a part of the through-hole 26. Accordingly, the head 32 cannot pass completely through the through-hole 26.

The rigid rod 28 in this example is a carriage bolt having a threaded shaft 30 and the head 32. The head 32 is disposed at the first end 34, and preferably is countersunk within a corresponding recess 40 at the edge of the through-hole 26 of the elongate handle member 22.

The stopper member 42 is a structure or collection of structures fixedly supported on the rigid rod 28 within the interior 16 of the casket base 10. The stopper member 42 includes extensions that exceed a diameter of at least a portion of the side panel opening 38. In other words, the stopper member 42 is configured such that it cannot pass through the side panel opening 38. In the embodiment described herein, the stopper member 42 is a washer 46 and hex nut 48 in combination. The washer 46 is configured to fit over the threaded shaft 30 and the nut 48 having interior threads (not shown) which threadingly engage the threaded shaft 30. In the alternative, the stopper member 42 may suitably be a hex flange nut, or any other device.

The sleeve 44 is a plastic, metal or other tubular structure a relatively smooth outer surface 50. The sleeve 44 is hollow, and is concentrically interposed between inner walls of the side panel opening 38 and a portion of the rigid rod 28 that extends through the side panel opening 38. The sleeve 44 in this embodiment extends between and is trapped between the washer 46 and the elongate handle member 22. The smooth outer surface 50 facilitates ease of movement of the rigid rod 28 between the first position (FIG. 2) and the second position (FIG. 3). In particular, without the sleeve 44, the rougher surface created by the threads on the threaded shaft 30 would create frictional resistance with the inner surface of the side wall opening 38, thereby making it more difficult to move the elongate handle member 22 between the first position and the second position.

In operation, the retractable handle arrangement 20 is disposed in the first (retracted) position as shown in FIG. 2. In that position, the elongate handle member 22 sits at its lowest point, adjacent to the side panel 11. In the embodiment, of FIGS. 2 and 3, the molded plaques 15 prevent the elongate handle member 22 from touching the side panel 11. This allows some space (on the order of 0.25 to 0.50 inches) for the user to place her fingers between the elongate handle member 22 and the side panel 11 when attempting to move the member 22 into the second (extended) position. In the first position of FIG. 2, the width footprint of the casket base 10 is smaller than other caskets having the same interior width and bar handle structures, because the bar handles do not stick out from the sides as far as would be necessary to facilitate gripping of the bar.

When the casket base 10 is to be moved, a user applies a pulling force urging the elongate handle member 22 outward and upward. The threaded shaft 30 and the sleeve 44 slide up through the side wall opening 38 until the stopper member 42 engages the inner surface 52 of the side panel 11. At that point the elongate handle member 22 is in the second (extended) position and the user and others can easily fit their hands around the elongate handle member 22 with the back of their hands facing the side panel 11. The user and others may then lift the casket base 10 by the handle member 22 (and the opposing handle member, not shown) and move the casket base 10 as necessary. After movement of the casket base 10, the elongate handle member 22 may be returned to the first position. The return of the elongate handle member 22 to the first position may occur due to gravity alone, or as a result of manipulation by the user(s) to push the elongate handle member 22 inward and downward.

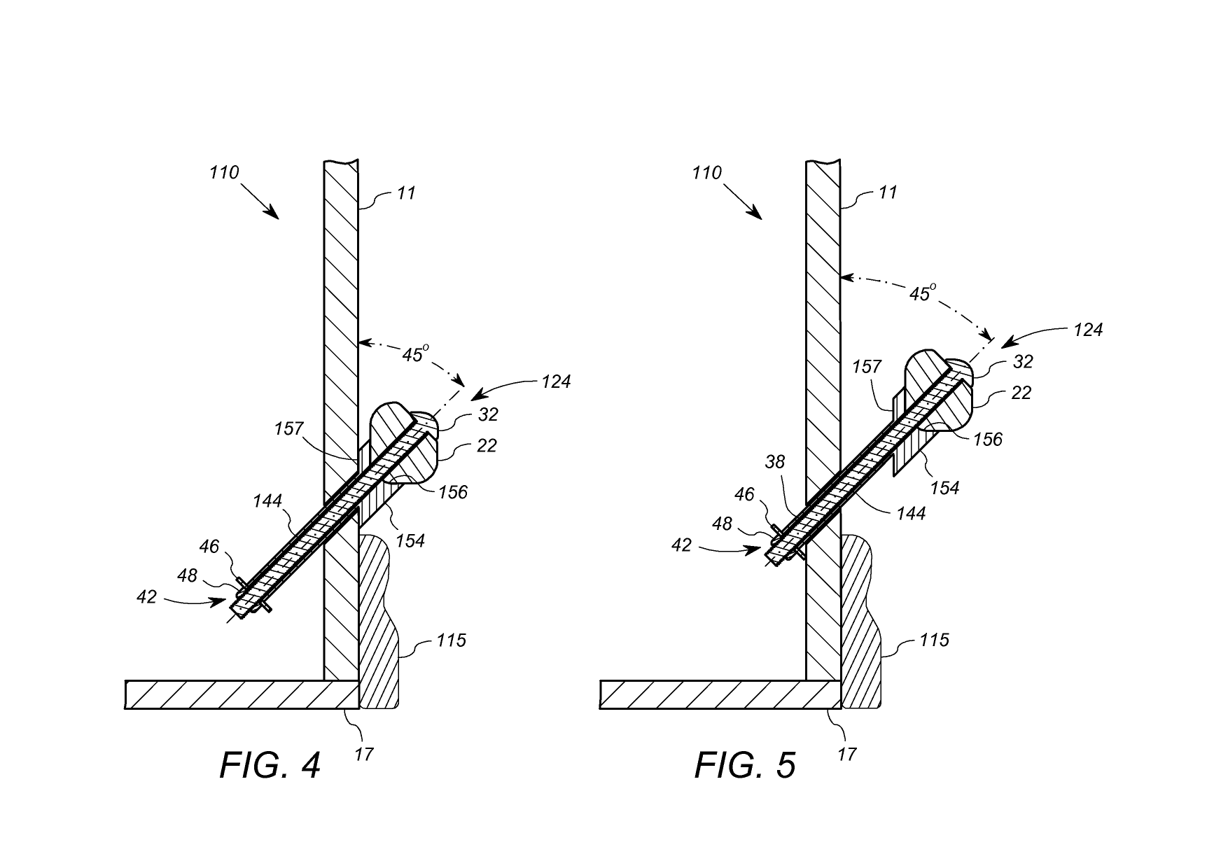

FIGS. 4 and 5 show an alternative slide mechanism 124 that may be used in the retractable handle mechanism 20. The slide mechanism 124 is suitable for use in an alternative the casket base 110. In this embodiment, the casket base 110 has the same general structure as the casket base 10 with the exception that the casket base 110 does not include molded plaques 15, and includes a base rail 115. Where the structures are unchanged, the same reference numbers as those used in connection with FIGS. 1-3 will be used.

The base rail 115 is molding strip, typically constructed of wood, that is affixed to the lower portion of the side panel 11. The use of a base rail 115, and not molded plaques 15, provides a different aesthetic appearance to the casket base 110.

The sliding mechanism 124 is identical to the sliding mechanism 24 of FIGS. 2 and 3 with the exception that the sleeve 44 has been replaced by an alternative sleeve 144 that includes an exterior spacer 154. The exterior spacer 154 is a wider portion of the sleeve 144 that cannot pass through the side wall opening 38. The exterior 154 spacer is configured to stop the downward and inward movement of the elongate handle member 22 at a position approximately 0.25 inches from the side panel 11. Thus, the first or retracted position (FIG. 4) of the elongate handle member 22 does not rest against the side wall, but rather at a distance that allows finger access to manipulate the elongate handle member 22 outward to the second or extended position (FIG. 5).

To this end, in this embodiment, the exterior spacer has a saddle structure 156 at one end affixed against the elongate handle member 22, and a chamfered edge 157 at the other end that aligns along a vertical plane parallel to the plane of the outer surface of the side panel 11 when the remainder of the sleeve 144 extends through the opening 38.

The operation of the slider mechanism 124 is otherwise identical to that of the slider mechanism 24 of FIGS. 2 and 3. However, instead of the molded plaques 15 limiting the downward and inward movement of the elongate handle member 22 in the first position, it is the exterior spacer 154 that limits the downward and inward movement of the elongate handle member 22, specifically, when the chamfered edge 157 contacts the side panel 11.

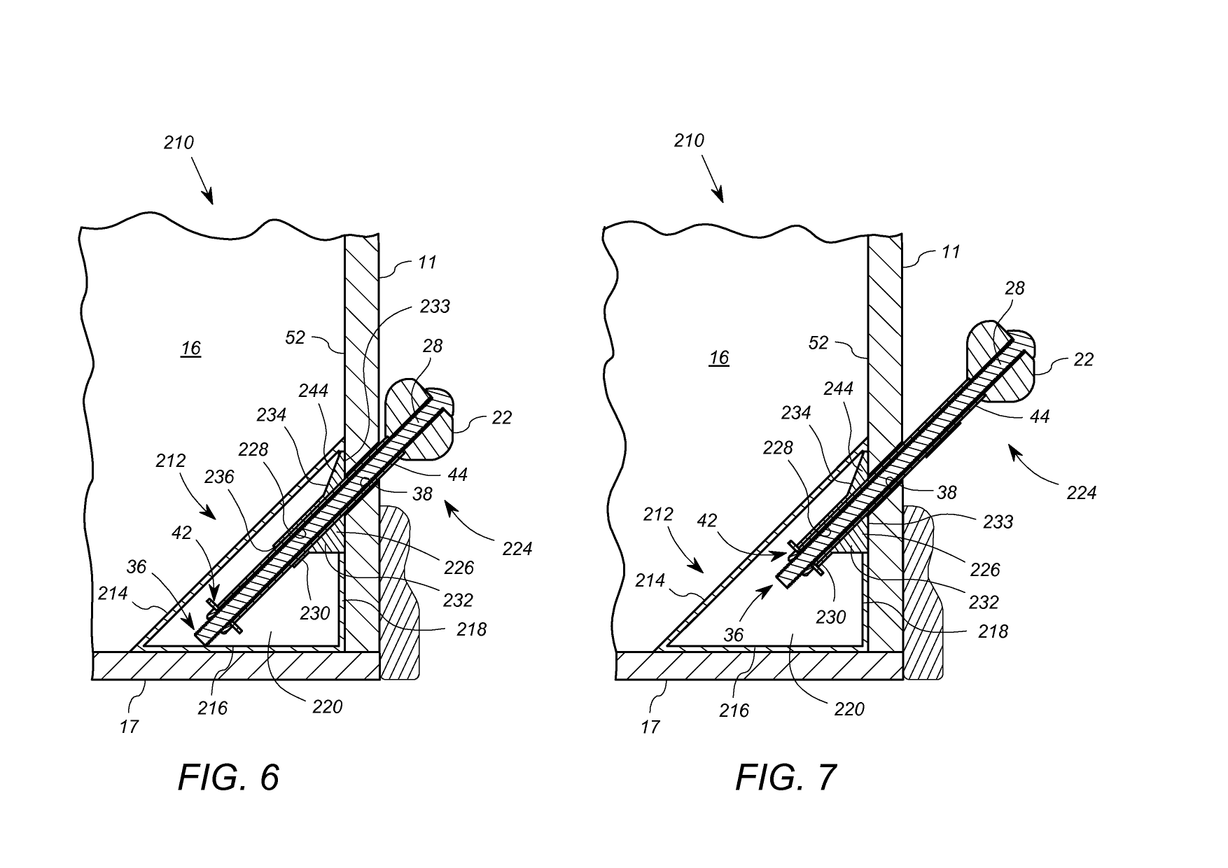

In yet another embodiment of the slider mechanism, the length of the rigid rod 28 can be extended such that it contacts the casket base (or floor) at a point where the elongate handle member 22 is spaced apart from the side panel 11 by an amount sufficient to allow manipulation of the fingers therebetween. In particular, FIGS. 6 and 7 discloses yet another alternative slider mechanism 224 that may be used in the retractable handle arrangement 20. In the embodiment of FIGS. 6 and 7, the slider mechanism is used in a casket base 210 having the general construction of the casket base 110 of FIGS. 4 and 5, except that the casket base 210 further includes a corner support 212.

In particular, the corner support 212 is an elongate element that may extend partially or fully along the length of the side panel 11. The corner support 212 in general forms a barrier over the portions of the slider mechanism 224 that are in the interior 16 of the casket base 210. This barrier prevents (or at least very substantially inhibits) the possibility of the slider mechanism 224 contacting the any portion of the deceased, not shown, within the interior 16 of the casket base 210.

To this end, the corner support 212 includes a barrier piece 214, a bottom support 216, and an upright support 218. In this embodiment, the corner support 212 is formed of a length of corrugated paper or other paper product that is folded twice along its length to form the barrier piece 214, the bottom support 216 and the upright support 218. Accordingly, the barrier piece 214, the bottom support 216 and the upright support 218 form three elongate surfaces that extend in a collinear manner. From the point of view of the cross-section as shown in FIGS. 6 and 7, the barrier piece 214 extends diagonally downward and inward, from the inner surface 52 of the side panel 11 at a location above the side wall opening 38, to the base panel 17. The bottom support 216 extends from the edge of the barrier piece 214 along the surface of the base panel 17 to the corner intersection of the base panel 17 and the side panel 11. The upright support 218 extends from the edge of the bottom support 216, up along the inner surface 52 of the side panel 11. The bottom support 216 and the upright support 218 serve to provide structural support to the barrier piece 214.

The barrier piece 214 thus defines an interior portion 220 in the corner of the interior 16 of the casket in which the slider mechanism 224 extends. As a consequence, the slider mechanism 224 is separated from the remainder of the interior 16 of the casket base 10. The body of the deceased within the interior 16 of the casket base 10 does not pass into the interior portion 220.

The slider mechanism 224 of FIGS. 6 and 7 is designed primarily for a casket, such as the caskets 110 and 210, that does not include molded plaques such as the molded plaque 15 of FIGS. 1, 2 and 3 to act as spacers between the elongate handle member 22 and the side panel 11. In this embodiment, the downward and inward travel (and resting point) of the elongate handle member 22 is arrested by the contact of the second end 36 of the rigid rod 28 against the base panel 17. (See FIG. 6). To this end, the location of the side wall opening 38, the angle of inclination of the side wall opening 38 and the length of the rigid rod 28 are selected such that the second end 36 contacts and engages the base panel 17 when the elongate handle member 22 has traveled a position that is slightly spaced apart (approximately 0.2″ to 0.5″) away from the side panel 11.

The embodiment of the slider mechanism 224 of FIGS. 6 and 7 also includes a sleeve bracket 226. The sleeve bracket 226 is affixed to the side panel 11, and includes an internal passageway 228 for receiving the sleeve 44 therethrough. The sleeve bracket 226 includes a tubular nose 230 and a bracket base 232. The bracket base 232 is in the form of a short frusto-cylindrical member that includes a flat vertical surface 233 for engaging the side wall and an angled surface 234 from which the tubular nose 230 extends. The flat vertical surface 232 has a diameter that is significantly larger than that of the side wall opening 38. The tubular nose 230 extends at an angled aligned with the angle of the side wall opening 38, preferably about 45° downward and inward. Accordingly, the internal passageway 228 aligns with the side wall opening 38 to receive the rigid rod 28 and sleeve 44 therethrough. The tubular nose 230 includes a bottom surface 236 at its end furthest from the side wall opening 38. The bottom surface 236 defines an annular surface that lies in a plane that is normal to an axis of the internal passageway 228.

The bracket 226 is affixed to the side panel 11, via adhesive and/or a fastener, not shown. In this embodiment, the upper portion of the bracket 226 forms a land area 244 through which one or more fasteners, not shown, may be used to connect the bracket 226 to the side panel 11.

In operation, the retractable handle arrangement 220 is disposed in the first (retracted) position as shown in FIG. 6. In that position, the elongate handle member 22 sits at its lowest point, adjacent to, but slightly spaced apart from, the side panel 11. In this embodiment, second end 36 of the rigid rod 28 rests against the base support 17 of the casket base 10 in the first position. In addition, the stopper member 42 is spaced apart from the bottom surface 236.

When the casket base 210 is to be moved, a user applies a pulling force urging the elongate handle member 22 outward and upward. The threaded shaft 30 and the sleeve 228 all move upward and outward through the interior passageway 228 and the side wall opening 38 until the stopper member 42 engages the bottom surface 236 of the bracket 226. At that point, the elongate handle member 22 is in the second (extended) position (see FIG. 7) and the user and others can fit their hands around the elongate handle member 22 with the back of their hands facing the side panel 11. The user and others may then lift the casket base 210 by the handles (e.g. elongate handle member 22) and move the casket base 210 as necessary. After movement of the casket base 210, the elongate handle member 22 may be returned to the first position.

In this embodiment, the bracket 226 serves to better distribute forces by providing a flat contact surface (the bottom surface 236) for the stopper member 42, e.g. the washer 46. In other words because the contact surface (washer 46) and the bottom surface 236 lie in the same plane in the second position as shown in FIG. 7, the forces from lifting are more evenly distributed than they are in the embodiments of FIGS. 2-5.

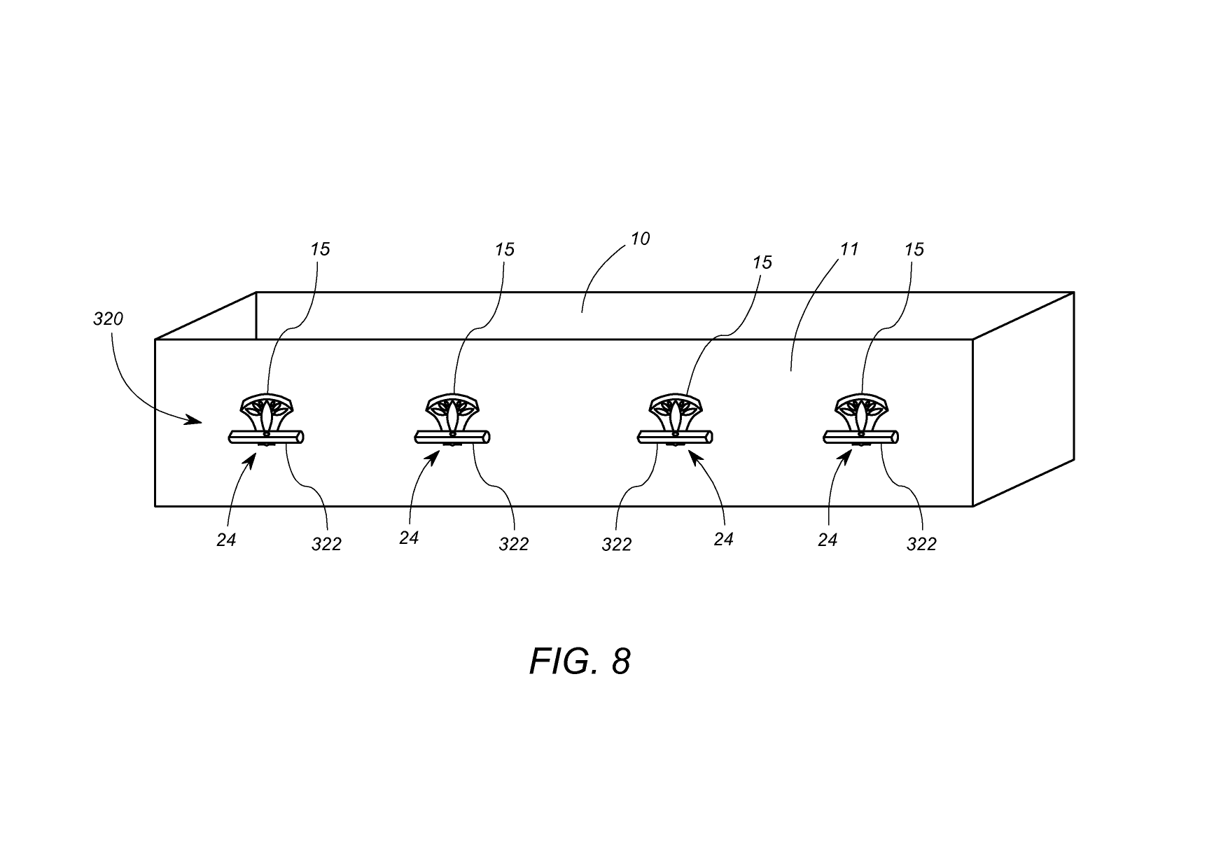

FIG. 8 shows a perspective view of an alternative retractable handle arrangement 320 that for use in a casket base such as the casket base 10 of FIG. 1. The retractable handle arrangement 320 includes a plurality of elongate handle members 322, each associated with the slider mechanism 24. In other words, instead of using singled handle member on each side of the casket, such as the elongate handle member 22 of FIG. 1, the embodiment of FIG. 8 uses multiple shorter elongate handle members 322. The slider mechanism 24 is identical to that of FIGS. 2 and 3. It will be appreciated, however, that the elongate handle members 322 may alternatively be used with either of the slider mechanisms 124, 224 of FIGS. 4-7.

In yet another variant of the embodiment of FIG. 8, the elongate handle members 322 may be implemented as an integrally formed part of the rigid rod 28. In other words, such a rigid rod would be “T”-shaped, and act as a handle as well as part of the slider mechanism.

It will be appreciated that the above described embodiments are merely exemplary, and that those of ordinary skill in the art may readily devise their own implementations that incorporate the principles of the present invention and fall within the spirit and scope thereof. For example, it will be appreciated that the slider mechanism 24 of FIGS. 2 and 3 may readily be used in casket bases having a design of (or more similar to) the casket bases 110, 210 of FIGS. 4-7. Likewise, the slider mechanisms 124 and 224 may suitably be used in casket bases that include decorative molding plaques similar to those of FIG. 1. All of the embodiments may employ the corner supports 212 or any other barrier affixed between the slider mechanisms 24, 124 and 224 and the part of the interior of the casket in which the deceased is located.

It will further be appreciated that the molded plaques 15 of FIGS. 1-3 may be replaced by any rigid plate, spacer, post, block or other structure that is affixed to the outer surface of the side wall 11 and is aligned with a part of the elongate handle member 22. Such structure need only have a thickness of 0.2 to 0.5 inches to ensure that the elongate handle member 22 (or 322) is spaced from the side wall 11, even in the retracted position.

We claim:

1. A retractable handle arrangement for a casket, comprising:
an elongate handle member having a length extending parallel to a side panel of the casket, the elongate handle member having a through-hole extending transverse to the length;
a rigid rod extending through the through-hole, the rigid rod having a first end and a second end, the first end having a head having a diameter exceeding a diameter of at least a part of the through-hole, the rigid rod extending through a side panel opening such that the second end is disposed within an interior of the casket; and
a stopper member fixedly supported on the rigid rod within the interior of the casket, the stopper member having a diameter that exceeds a diameter of at least a portion of the side panel opening.

2. The retractable handle arrangement of claim 1, wherein the rigid rod includes a threaded shaft portion, and wherein the stopper member includes interior threads for rotatably engaging the threaded shaft portion.

3. The retractable handle of claim 2, wherein the stopper member includes a nut and a washer.

4. The retractable handle arrangement of claim 2, further comprising a sleeve interposed between inner walls of the side panel opening and a portion of the rigid rod that extends through the side panel opening.

5. The retractable handle arrangement of claim 4, wherein the sleeve is fixedly supported and extends between the stopper member and the elongate handle member.

6. The retractable handle of claim 5, further comprising a sleeve bracket, the sleeve bracket including a having a passage through which the rigid rod and the sleeve pass, the bracket affixed to the side panel.

7. The retractable handle of claim 6, wherein the sleeve bracket includes a surface proximate an end of the passage, the surface lying in a plane parallel to a plane of a contact surface of the stopper member.

8. The retractable handle of claim 7, further comprising means for preventing the elongate handle member from contacting the side panel.

9. A retractable handle arrangement for a casket having a side panel, the retractable handle moveable between a first position with respect to the casket and a second position with respect to the casket, the retractable handle arrangement comprising:
an elongate handle member having a length extending parallel to the side panel of the casket,
a rigid rod affixed to the elongate handle member, the rigid rod having a first end and a second end, the rigid rod extending through a side panel opening such that the second end is disposed within an interior of the casket; and
a stopper member fixedly supported on the rigid rod within the interior of the casket, the stopper member having a diameter that exceeds a diameter of at least a portion of the side panel opening.

10. The retractable handle arrangement of claim 9, wherein the rigid rod includes a threaded shaft portion, and wherein the stopper member includes interior threads for rotatably engaging the threaded shaft portion.

11. The retractable handle of claim 10, wherein the stopper member includes a nut and a washer.

12. The retractable handle arrangement of claim 9, further comprising a sleeve interposed between inner walls of the side panel opening and a portion of the rigid rod that extends through the side panel opening.

13. The retractable handle arrangement of claim 12, wherein the sleeve is fixedly supported and extends between the stopper member and the elongate handle member.

14. The retractable handle of claim 12, further comprising a sleeve bracket, the sleeve bracket including a having a passage through which the rigid rod and the sleeve pass, the bracket affixed to the side panel.

15. The retractable handle of claim 9, further comprising means for preventing the elongate handle member from contacting the side panel.

16. A casket base comprising:
a plurality of panels arranged as an open box, the plurality of panels including a side panel and a bottom panel;
a retractable handle arrangement moveable between a first position with respect to the casket and a second position with respect to the casket, the retractable handle arrangement comprising,
an elongate handle member having a length extending parallel to the side panel of the casket,
a rigid rod affixed to the elongate handle member, the rigid rod having a first end and a second end, the rigid rod extending through a side panel opening such that the second end is disposed within an interior of the casket; and
a stopper member fixedly supported on the rigid rod within the interior of the casket, the stopper member having a diameter that exceeds a diameter of at least a portion of the side panel opening.
a barrier support extending diagonally between the side panel and the bottom panel, wherein a portion of the rigid rod within the interior of the casket is disposed between the barrier support, the side panel and the bottom panel.

17. The casket base of claim 16, wherein:
the elongate handle member and the rigid rod comprise separate structures;
the rigid rod extends through a through-hole within the elongate handle member; and
the first end of the rigid rod includes a head having a diameter exceeding that of the through-hole.

18. The casket base of 17, wherein the rigid rod includes a threaded shaft portion, and wherein the stopper member includes interior threads for rotatably engaging the threaded shaft portion.

19. The casket base of 16, wherein the rigid rod includes a threaded shaft portion, and wherein the stopper member includes interior threads for rotatably engaging the threaded shaft portion.

20. The retractable handle of claim 16, further comprising means for preventing the elongate handle member from contacting the side panel.
